(19) United States
(12) Patent Application Publication
(10) Pub. No.: US 2014/0379186 A1
(43) Pub. Date: Dec. 25, 2014

(54) ELECTRONIC CONTROL DEVICE

(71) Applicant: DENSO CORPORATION, Kariya-city (JP)

(72) Inventor: Tooru SUZUKI, Toyota-city (JP)

(21) Appl. No.: 14/302,494

(22) Filed: Jun. 12, 2014

(30) Foreign Application Priority Data
Jun. 25, 2013 (JP) 2013-133031

(51) Int. Cl. B60W 20/00; B60W 40/12; B60W 30/18; B60W 10/06; B60W 10/08

(52) U.S. Cl. CPC B60W 20/20; B60W 10/06; B60W 10/08; B60W 30/18036; B60W 40/12; Y10S 903/93
USPC 701/22; 180/65.265; 903/930

(57) ABSTRACT

An electronic control device is mounted to a hybrid vehicle and controls the hybrid vehicle. The hybrid vehicle has an engine and a motor and has a driving force limitation portion limiting a driving force of the motor when a motor temperature is equal to or more than an upper limit temperature. The electronic control device includes a stop determination portion, an obtaining portion, an estimation portion, an extra time determination portion, and a switching portion. The stop determination portion determines whether the hybrid vehicle is in a motor travelling mode and in a vehicle stop state. The obtaining portion obtains a physical quantity from an external, and the electronic control device estimates an extra time. The estimation portion calculates a temperature change per unit time. The extra time determination portion determines whether the extra time reaches a predetermined time. The switching portion switches a travelling mode.

### CROSS REFERENCE TO RELATED APPLICATION

This application is based on Japanese Patent Application No. 2013-133031 filed on Jun. 25, 2013, the disclosure of which is incorporated herein by reference.

### TECHNICAL FIELD

The present disclosure relates to an electronic control device controlling and mounted to a hybrid vehicle. A power source of the hybrid vehicle corresponds to an engine and/or a motor.

### BACKGROUND OF THE INVENTION

### Patent Document 1: JP-A-2007-186048

Conventionally, patent document 1 discloses an electronic device controlling a hybrid vehicle.

Patent document 1 includes a first upper limit temperature and a second upper limit temperature. The second upper limit temperature is higher than the first upper temperature, which is usually set. The second upper limit temperature is set so as to control an output of a motor when the vehicle climbs a hill backward. The electronic device controls the output of the motor using the second upper limit temperature and a motor temperature.

Some drivers uses only a motor as a power source, and balances a driving force by the motor and a slide down force, so that some drivers makes the hybrid vehicle be into an vehicle stop state in an uphill. The slide down force is applied to the hybrid vehicle in a slide down direction by the gravity.

The inventor of the present disclosure has found the followings. However, when the vehicle stop state is realized using only a driving force of the motor, the motor does not rotate at all or hardly rotate, the motor is in a heavy load state, and the motor temperature increases rapidly. Therefore, as described in patent document 1, even when the second upper limit temperature is set as another upper limit temperature, the motor temperature soon reaches the second upper limit temperature. The driving force of the motor may be controlled. Therefore, the slide down force exceeds the driving force of the motor, and a slide down of the hybrid vehicle may occur.

### SUMMARY

It is an object of the present disclosure to provide an electronic control device controlling a hybrid vehicle and preventing a slide down of the vehicle in an uphill.

According to one aspect of the present disclosure, an electronic control device mounted to a hybrid vehicle and controlling the hybrid vehicle is provided. The hybrid vehicle has an engine and a motor as a power source generating a driving force for driving a driving shaft of the hybrid vehicle and has a driving force limitation portion limiting a driving force of the motor when a motor temperature is equal to or more than a predetermined upper limit temperature. The electronic control device includes a stop determination portion, an obtaining portion, an estimation portion, an extra time determination portion, and a switching portion. The stop determination portion determines whether the hybrid vehicle is in a motor travelling mode where only the motor is used as the power source, and whether the hybrid vehicle is in a vehicle stop state where the driving force of the motor is balanced with a slide down force applied to the hybrid vehicle in a slide down direction by gravity. The obtaining portion obtains a physical quantity from an external of the electronic control device so as to estimate an extra time before the motor temperature reaches the upper limit temperature when the stop determination portion determines that the hybrid vehicle is in the motor travelling mode and in the vehicle stop state. The estimation portion calculates a temperature change of the motor per unit time based on the physical quantity obtained by the obtaining portion, and estimating the extra time based on the calculated temperature change. The extra time determination portion determines whether the extra time estimated by the estimation portion reaches a predetermined time. The switching portion switches a travelling mode of the hybrid vehicle from the motor travelling mode to a hybrid travelling mode when the extra time determination portion determines that the extra time reaches the predetermined time, in which the hybrid travelling mode uses at least the engine as the power source.

According to the above technical features, it is possible that the extra time, which is the amount of a time before the motor temperature reaches the upper limitation temperature, is estimated, and It is possible to drive the engine before the motor temperature reaches the upper limitation temperature, that is, before the driving force of the motor is limited. Therefore, it is possible to prevent the slide down of a vehicle on an uphill.

In addition, when the extra time reaches a predetermined time, an engine is driven. That is, since the engine is not driven as much as possible, it is possible to prevent the slide down and to improve a fuel efficiency.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a drawing illustrating a schematic configuration of a hybrid vehicle using an electronic control device according to a first embodiment;

FIG. 2 is a drawing illustrating a balancing between a driving force of a motor and a slide down force in an uphill;

FIG. 3 is a drawing illustrating a flowchart of a processing to prevent a slide down using the electronic control device;

FIG. 4 is a flowchart illustrating an extra time estimation processing in FIG. 3;

FIG. 5 is a drawing illustrating an extra time estimation;

FIG. 6 is a timing chart illustrating a switching of traveling modes;

FIG. 7 is a flowchart illustrating a first modified example of the extra time estimation processing;

FIG. 8 is a flowchart illustrating the extra time estimation processing in the electronic control device according to a second embodiment;

FIG. 9 is a drawing illustrating a schematic configuration of the electronic control device according to a third embodiment; and

FIG. 10 is a drawing illustrating the extra time estimation processing in the electronic control device.

### DETAILED DESCRIPTION

Following, embodiments of the present disclosure will be described with referring to the drawings. Incidentally, identical symbols will be given to common elements or associated elements in each embodiment.

### First Embodiment

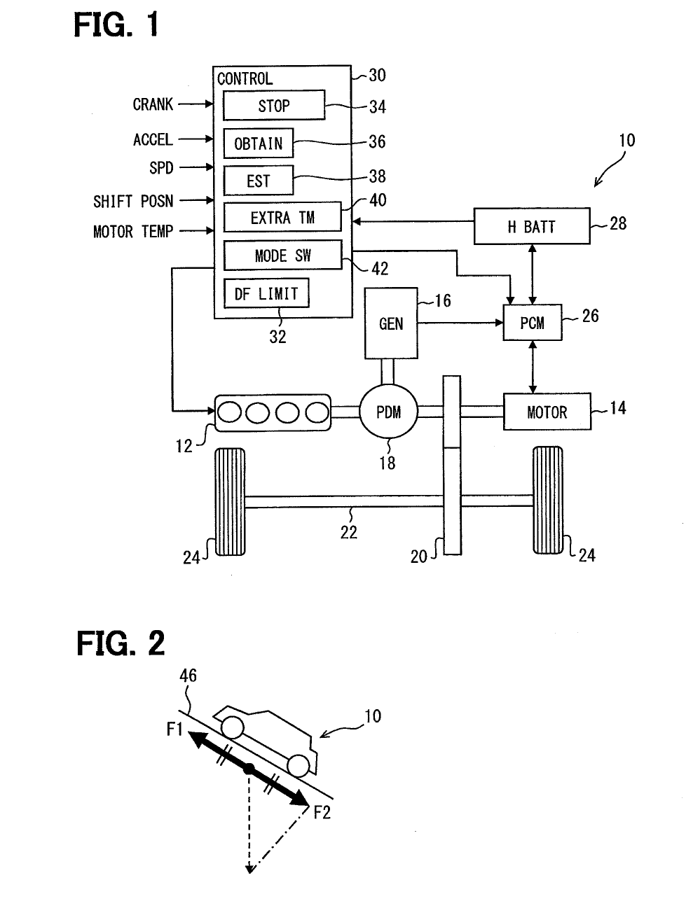

A schematic configuration of a hybrid vehicle that an electronic control device according to the present embodiment is applied will be explained with referring to FIG. 1.

As described in FIG. 1, a hybrid vehicle 10 includes an engine 12 and a motor 14. The hybrid vehicle 10 in a normal travelling state travels using a driving force generated by the motor 14, or using a driving force generated by the engine 12 and the motor 14 based on a state. The engine 12 may be referred to as an internal combustion engine. The motor 14 may be referred to a motor generator, an electric motor, or the like.

The hybrid vehicle 10 includes a generator 16, which is supplied with the driving force and generates electricity, in addition to the engine 12 and the motor 14. The generator 16 is also used as a starter (or a cranking motor) when the engine 12 starts up. The engine 12, the motor 14, and the generator 16 are connected each other through a power dividing mechanism 18. The power dividing mechanism 18 distributes the driving force of the engine 12 to the generator 16 and the reducer 20. In addition, the power dividing mechanism 18 functions as a gearhead (or a gearbox).

The reducer 20 transmits power generated by the engine 12, the motor 14, and the generator 16 to a driving wheel 24 through a driving shaft 22, or transmits an actuation of the driving wheel 24 to the engine 12, the motor 14, and/or the generator 16.

In addition, the hybrid vehicle 10 includes a power control module 26 and a high voltage battery 28. The high voltage battery 28 is a chargeable and dischargeable DC power supply, and, for example, includes a secondary battery such as a nickel hydride battery and a lithium ion battery.

The power control module 26 is connected to the motor 14, the generator 16, and the high voltage battery 28. The power control module 26 has an inverter and a boost converter (not shown). The inverter converts a direct current (DC) of a high voltage battery into an alternating current (AC) of the motor 14 and the generator 16, and vice versa. The inverter performs current control. On the contrary, the boost converter boosts the voltage of the high voltage battery 28 to high voltage, and supplies the high voltage to the inverter. The boost converter lowers the voltage of the high voltage from the inverter so as to charge the high voltage battery 28.

Therefore, the power generated by the generator 16 is supplied to the motor 14 through the inverter of the power control module 26. The power generated by the generator 16 may be charged into the high voltage battery 28 through the inverter and the boost converter of the power control module 26. A regenerative power generated by the motor 14 may be charged into the high voltage battery 28 through the power control module 26. Furthermore, the power charged by the high voltage battery 28 may be supplied to the motor 14 through the power control module 26.

In addition, the hybrid vehicle 10 has an electronic control device 30. The electronic control device 30 controls the whole of the driving system of the hybrid vehicle 10 including the engine 12, the motor 14, the generator 16, the power dividing mechanism 18, and the power control module 26. The electronic control device 30 includes a microcomputer having a CPU, a ROM, a RAM, a register, or the like. The microcomputer executes various data processings temporarily using the RAM and a register as a storage region based on an input signal or a program stored in the ROM.

The electronic control device 30 calculates a target driving force from a vehicle operation of an operator, a vehicle speed, or the like. The electronic control device 30 integrally controls the engine 12, the motor 14, and the generator 16 so as to attain the target driving force. Therefore, the electronic control device 30 determines a distribution of (i) the driving force required for the engine 12, (ii) the driving force required for the motor 14, (iii) the driving force required for the generator 16 with respect to the target driving force, according to a travelling state of the vehicle.

The electronic control device 30 controls a throttle valve (not shown) to a suitable opening in order to generate the driving force required in the engine 12, and controls the amount of a fuel oil consumption and ignition timing of the engine 12. In addition, the electronic control device 30 controls the power control module 26 in order to generate the driving force required in the motor 14 and the generator 16. The electronic control device 30 also monitors a charging state of the high voltage battery 28, and controls the charge and discharge of the high voltage battery 28.

The electronic control device 30 (corresponding to the microcomputer) includes a driving force limiting portion 32, a stop determination portion 34, an obtaining portion 36, an estimation portion 38, an extra time determination portion 40, and a mode switching portion 42.

The driving force limiting portion 32 obtains a signal representing a motor temperature from a temperature sensor detecting temperature of the motor 14, and obtains an upper limit temperature stored in advance from the ROM. When a motor temperature becomes equal to or more than the upper limit temperature, the driving force limiting portion 32 limits the driving force of the motor 14. In the present embodiment, in order to lower the temperature of the motor 14, a current supplied to the motor 14 is reduced before reaching the upper limit temperature. The driving force limiting portion 32 corresponds to a driving force limiting portion in the present disclosure.

The stop determination portion 34 determines whether the hybrid vehicle 10 is in a stop state by balancing a driving force of the motor 14 and a slide down force applied to the hybrid vehicle in a slide down direction by the gravity when (I) the hybrid vehicle 10 is in a motor travelling mode and (ii) the hybrid vehicle 10 is in an uphill. In the motor travelling mode, only the motor 14 provide the power source, and drives the hybrid vehicle 10. In the present embodiment, the driving force limiting portion 32 obtains a crank angle signal from a crank angle sensor, an accelerator opening signal from an accelerator position sensor, a vehicle speed signal from a speed sensor, and a shift position signal from a shift position sensor. Based on the signals, the stop determination portion 34 determines whether the hybrid vehicle 10 is in the motor travelling mode and is in a vehicle stop state. The stop determination portion 34 corresponds to a stop determination portion in the present disclosure.

Incidentally, the slide down direction is a downward direction along a slope of the uphill 46.

When the stop determination portion 34 determines that the hybrid vehicle 10 is in the motor travelling mode and in the stop state, the obtaining portion 36 obtains a physical quantity for estimating the extra time by reaching the upper limit temperature of the temperature of the motor 14 from the external part. In the present embodiment, the obtaining portion 36 obtains a signal of the motor temperature from a temperature sensor detecting temperature of the motor 14. Therefore, the motor temperature is obtained as the physical quantity. In addition, the time when the motor temperature is obtained is also obtained. The obtaining portion 36 corresponds to an obtaining portion in the present disclosure.

The estimation portion 38, based on the physical quantity obtained from the obtaining portion 36, calculates a temperature change per unit time of the motor 14, and estimates an extra time t1 based on the calculated temperature change. In the present embodiment, based on a previous value of the motor temperature and a present value of the motor temperature, a temperature change per a unit time is calculated and the extra time t1 is also calculated. The estimation portion 38 corresponds to an estimation portion in the present disclosure.

The extra time determination portion 40 determines whether the extra time t1 estimated by the estimation portion 38 has reached a predetermined time t2 set up in advance. In the present embodiment, the extra time determination portion 40 compares the extra time t1 calculated by the estimation portion 38 and the predetermined time t2, and determines whether the extra time t1 becomes equal to or less than the predetermined time t2. The extra time determination portion 40 corresponds to an extra time determination portion in the present disclosure.

The mode switching portion 42 switches a travelling mode of the hybrid vehicle 10 from the motor travelling mode to a hybrid travelling mode when the extra time determination portion 40 determines that the extra time t1 reaches the predetermined time t2. In the hybrid travelling mode, at least the engine 12 is used as the power source, and therefore, in the hybrid travelling mode, a case where only the engine 12 is used as the power source is included. In the present embodiment, the engine 12 and the motor 14, or only the engine 12 are used in the hybrid travelling mode. As described above, since the engine 12 is driven and a driving force of the vehicle is supported by a driving force of the engine 12, it is possible to reduce current supplying to the motor 14. Therefore, by switching the travelling mode into the hybrid travelling mode, in which at least the engine 12 is used as the power source, it is possible to lower the temperature of the motor 14 before the temperature reaches the upper limit temperature. The mode switching portion 42 corresponds to a switching portion in the present disclosure.

Incidentally, the electronic control device 30 may include not only one ECU (Electronic Control Unit), but also multiple ECUs.

For example, a HV-ECU, an engine ECU, a motor ECU, and a battery ECU may be connected with each other. The ECUs may perform an integral control, so that the whole of the driving system of the hybrid vehicle 10 may integrally controlled. Incidentally, so that the HV-ECU attains the target driving force, the HV-ECU integrally controls the engine 12, the motor 14, and the generator 16. The engine ECU controls the engine 12 based on a control instruction from the HV-ECU. The motor ECU controls the motor 14, the generator 16 and the power control module 26 based on a control instruction from the HV-ECU. The battery ECU monitors the charging state of the high voltage battery 28, and controls a charge and discharge of the high voltage battery 28.

Some operators uses only the motor 14 as the power source on an uphill 46, and controls the hybrid vehicle 10 to be in the stop state by balancing a driving force F1 by the motor 14 and a slide down force F2 applied to the hybrid vehicle 10 in the slide down direction by the gravity as described in FIG. 2.

In this case where the hybrid vehicle 10 is in the stop state, since the motor 14 does not rotate or hardly rotate when a current is flowed in the motor 14, the motor 14 is in a heavy load state, and the motor temperature increases rapidly. Therefore, the temperature of the motor 14 may reach the upper limit temperature, and the driving force of the motor 14 may be limited. Therefore, the slide down force F2 may exceed the driving force F1 of the motor 14, and a slide down of the hybrid vehicle 10 may occur.

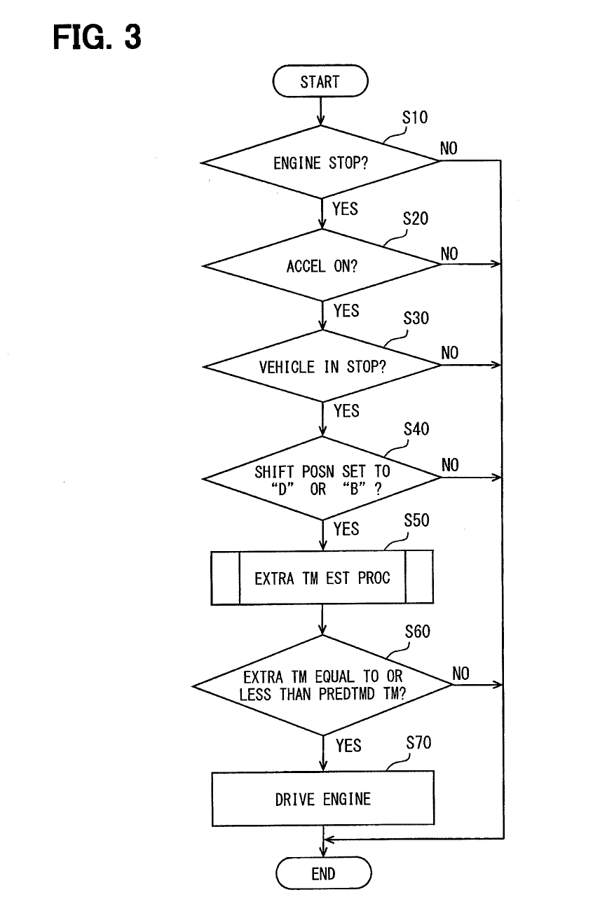

Following, with referring to FIG. 3, a processing to prevent the slide down on the uphill will be described, the processing executed by the electronic control device 30.

The electronic control device 30 determines whether the engine 12 is in a stop state based on the crank angle signal obtained from the crank angle sensor (S10). That is, the electronic control device 30 determines whether the hybrid vehicle 10 is in the motor travelling mode.

In S10, when it is determined that the engine 12 is in the stop state, the electronic control device 30 determines whether an accelerator is in an ON state based on an accelerator opening signal obtained from the accelerator opening sensor (S20). On the contrary, when it is determined that the engine 12 drives in S10, the processing is completed without proceeding to S20.

In S20, when it is determined that the accelerator is in the ON state, the electronic control device 30 determines whether the hybrid vehicle 10 is in the stop state based on the vehicle speed signal obtained from the speed sensor (S30). In this determination at S30, it is determined whether a vehicle speed is equal to or less than a predetermined threshold value, for example 5 km/h. On the contrary, in S20, it is determined that the accelerator is in an OFF state, the processing is completed without proceeding to S30 or subsequent ones.

In S30, when it is determined that the hybrid vehicle 10 is in the stop state, the electronic control device 30 determines whether a shift position corresponds to a drive (D) range or a regenerative brake (B) range based on the shift position signal obtained from the shift position sensor (S40). On the contrary, when it is determined that the hybrid vehicle 10 is not in the stop state in S30, the processing is completed without proceeding to S40 or subsequent steps.

According to the processing of S10 to S40, it is possible to determine that the hybrid vehicle 10 is in the motor travelling mode and in the vehicle stop state on the uphill. Incidentally, S10 to S40 correspond to a stop determination portion in the present disclosure.

When it is supposed that the hybrid vehicle 10 is in the motor travelling mode and in the stop state on the uphill by the processing of S40, the electronic control device 30 executes the extra time estimation processing, which estimates the extra time t1 (S50). A detail of this processing will be described below. S50 corresponds to an obtaining portion and an estimation portion in the present disclosure.

The electronic control device 30 determines whether the extra time t1 estimated in S50 reaches the predetermined time t2, which is set up in advance (S60). In the present embodiment, the electronic control device 30 compares the extra time t1 and the predetermined time t2, and determines whether the extra time t1 is equal to or less than the predetermined time t2. The processing in S60 corresponds to an extra time determination portion in the present disclosure.

When it is determined that the extra time t1 reaches the predetermined time t2, the electronic control device 30 causes the engine 12 to be driven (S70). When the electronic control device 30 causes the engine 12 to be driven, a driving force by the motor 14 is not limited, and it is possible to drive the engine 12. In the present embodiment, the travelling mode of the hybrid vehicle 10 is switched from the motor traveling mode to the hybrid travelling mode, in which at least the engine 12 is used as the power source. Accordingly, it is possible to reduce a current supplied to the motor 14. S70 corresponds to a switching portion in the present disclosure. On the contrary, when it is determined that the extra time t1 does not reach the predetermined time t2, the processing is completed without proceeding to S70.

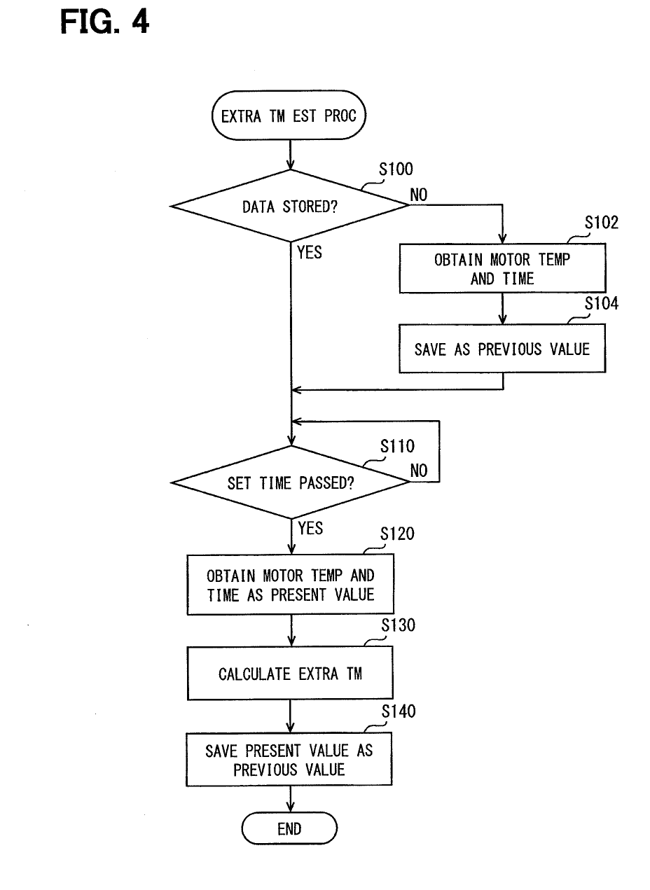

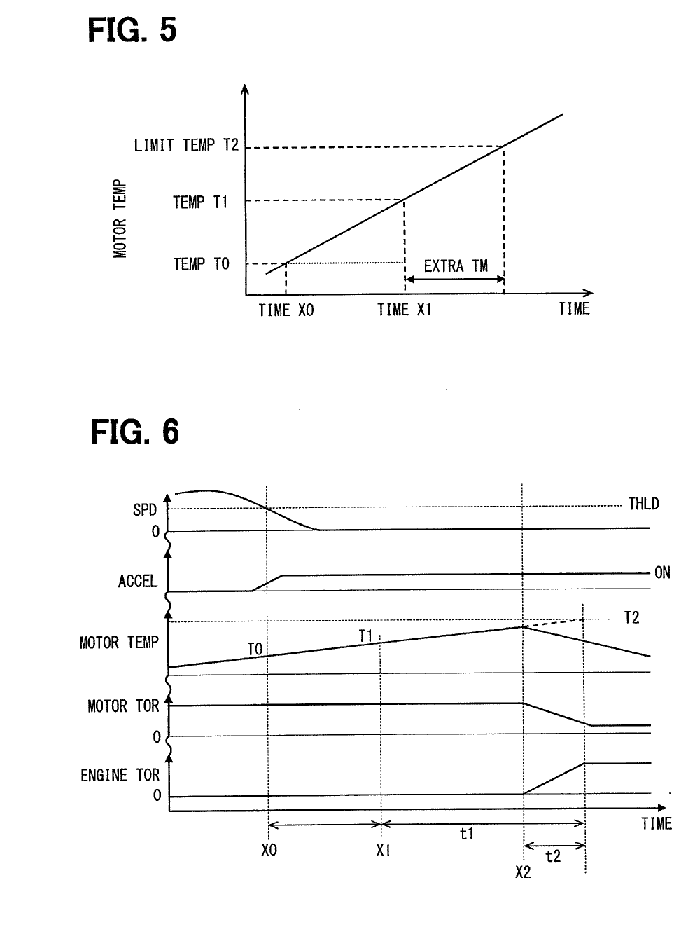

The extra time estimation processing will be explained with referring to FIG. 4 and FIG. 5.

As described in FIG. 4, the electronic control device 30 determines whether a previous value is stored in the RAM (8100). Incidentally, the previous value is a stored data, and includes a motor temperature and the time when the motor temperature is obtained.

In S100, when it is determined that the data (corresponding to the previous data) is not stored, the electronic control device 30 obtains a signal of the motor temperature and the time when the signal is obtained (S102). The electronic control device 30 stores the motor temperature and the time into the RAM as the previous value (8104). S102 and 8104 are processings in which an initial value is obtained and stored as the previous value at the time of the first processing after the motor travelling mode and a vehicle stop state are determined by S10 to S40, which are described in FIG. 3.

The electronic control device 30 determines whether a preset period of time, which is set up in advance, has passed from the time of the previous value (S110). The time of the previous value represents the time when the electronic control device 30 obtains the signal of the motor temperature. S110 is repeatedly executed until the preset period of time is passed from the time of the previous value. Incidentally, the time of the previous value represent the time when the previous value is stored.

When it is determined that the stored data is stored in the RAM in S100, the processing proceeds to S110. In S110, the time of the previous value stored in the RAM is used. On the contrary, when it is determined that the stored data is not stored in the RAM, the electronic control device 30 uses the time of the previous value stored into the RAM at S104.

In S110, when it is determined that an elapsed time i equal to or more than the set time, the electronic control device 30 obtains the signal of the motor temperature and the time when the signal is obtained. That is, the electronic control device 30 obtains present values of the motor temperature and the time (S120). Incidentally, the present value of the motor temperature may be referred to as a present motor temperature, and the present value of the time may be referred to as a present time. Similarly, the previous value of the motor temperature may be referred to as a previous motor temperature, and the present value of the time may be referred to as a previous time.

The electronic control device 30 calculates a change of the motor temperature between the present value and the previous value, which is read out from the RAM, per unit time. The electronic control device 30 calculates and estimates the extra time t1 before the motor temperature reaches the upper limit temperature based on the calculated change of the motor temperature (S130). In the estimation processing, it is possible to calculate the extra time t1 with referring the following expression, for example:

t1=(X1−X0)×(T2−T1)/(T1−T0) (expression).

The previous value corresponds to a temperature T0, and a time X0. The present value corresponds to a temperature T1, and a time X1. The upper limit temperature corresponds to T2.

After calculating the extra time #1, the electronic control device 30 stores and updates the previous value in the RAM with the present value. Incidentally, the previous value stored in the RAM is reset by a determination that the hybrid vehicle 10 is not in the stop state.

Incidentally, S102 and S120 correspond to an obtaining portion in the present disclosure.

The effects of the electronic control device 30 according to the present embodiment will be explained.

According to the electronic control device 30 in the present embodiment, the electronic control device 30 estimates the extra time t1 before the motor temperature reaches the upper limit temperature T2. It is possible to drive the engine 12 before the motor temperature reaches the upper limit temperature T2, that is, before the driving force of the motor 14 is limited. Therefore, on the uphill, it is possible to prevent the slide down of the hybrid vehicle 10.

When the extra time t1 reaches the predetermined time t2, the engine 12 is driven. That is, the engine is not driven as much as possible, and it is possible to prevent the slide down and to improve the fuel efficiency.

Furthermore, in the present embodiment, the electronic control device 30 obtains the motor temperature, and estimates the extra time t1 from a temporal change of the motor temperature. Therefore, since the extra time t1 is estimated from the temperature of the motor 14, it is possible to estimate the extra time t1 before the temperature of the motor 14 reaches the upper limit temperature T2 more accurately.

In the present embodiment, it is determined whether the estimated extra time t1 is equal to or less than the predetermined time t2 set up in advance, so that it determined whether the extra time t1 reaches the predetermined time t2. According to this configuration, when the extra time t1 has a surplus with respect to the predetermined time t2, the extra time t1 is calculated again. That is, until the extra time t1 reaches the predetermined time t2, the extra time t1 is repeatedly calculated. Therefore, it is possible to calculate a temperature change per unit time more precisely.

FIG. 6 illustrates an example of a travelling mode switching operation for preventing the slide down.

The vehicle speed coincides with the threshold value (for example, 5 km/h) at the time X0, and is equal to or less than the threshold value after the time X0. Therefore, the vehicle is in the vehicle stop state after the time X0. As described in FIG. 6, the accelerator is an ON state after the time X0. As described in an engine torque and a motor torque in FIG. 6, the engine 12 at time X0 is in the stop state, and only the motor 14 is driven. The shift position is set into the D range (not shown).

In this case, the vehicle is in the vehicle stop state, a predetermined torque of the motor 14 is required. The slide down is prevented by the driving force of the motor 14. Therefore, the motor temperature increases in accordance with the temporal change. Incidentally, in FIG. 6, for convenience, it is supposed that a change (inclination) of the motor temperature per unit time is constant.

In the present embodiment, the motor temperature and the time are obtained at the time X0. The motor temperature T0 and the time X0 at the time X0 are stored as the previous value. At the time X1 after the preset period of time is passed from the time X0, the motor temperature and the time are obtained. In another words, a time interval between the time X0 and the time X1 corresponds to the preset period of time. It is supposed that the temperature change per unit time is constant, and the extra time t1 at the time X1 is calculated from the motor temperature, the time X1, the previous value, and the upper limit temperature T2. Incidentally, the motor temperature T1 and the time X1 correspond to the present value.

As described in FIG. 6, when the calculated extra time t1 is longer than the predetermined time t2, the present value is changed into the previous value, and then, the motor temperature and the time are obtained again after the preset period of time is passed. The extra time #1 is calculated again. In FIG. 6, the time X2 corresponds to a time after a difference time corresponding to a difference between the predetermined time t2 and the extra time t1 is passed from the time X1. Accordingly, a required torque of the motor 14 may be reduced, and the motor temperature may also be reduced.

As described above, according to the present disclosure, it is possible to drive the engine 12 and to reduce the torque of the motor 14 before the motor temperature reaches the upper limit temperature T2, that is, before the driving force of the motor 14 is limited.

### Another Embodiment

In the processing described in FIG. 4, S110 may be omitted. In a case where 3110 is included, it is possible to reduce a load of the CPU. Furthermore, it is possible that an acquisition timing of the motor temperature is set almost constant.

Alternatively, in the processing described in FIG. 4, 3140 may be omitted. That is, the initial value may be used as the previous value continuously.

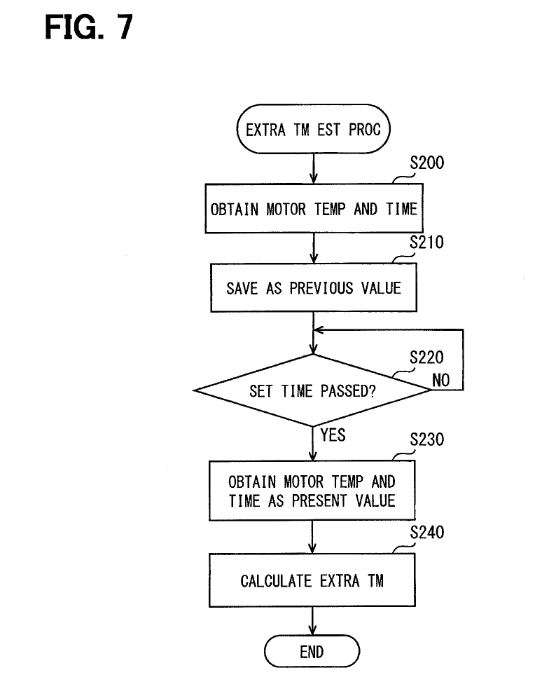

Alternatively, as described in a first another embodiment in FIG. 7, the electronic control device 30 obtains the motor temperature and the time at first (S200), and stores the obtained value as the previous value into the RAM (S210). The electronic control device 30 determines whether the preset period of time, which is set up in advance, is passed from the previous time (S220), and when the preset period of time is passed, the motor temperature and the time are obtained as the present value (S230). In S240, the electronic control device 30 calculates the extra time t1 from the present value and the previous value, which is read out from the RAM (S240). Therefore, the motor temperature and the time may be obtained twice in each time, and the extra time t1 may be calculated from the two obtained data. Incidentally, in the processing described in FIG. 7, S220 may be omitted. In FIGS. 7, S200 and S230 correspond to an obtaining portion, and S240 corresponds to an estimation portion,

### Second Embodiment

In the second embodiment, a description about a part that is common with the electronic control device 30 described in the above embodiment will be omitted.

In the present embodiment, the obtaining portion 36 obtains a value of a current flowing in the motor 14 as the physical quantity for estimating the extra time t1. The estimation portion 38 calculates a temperature change per unit time from the obtained current value, and estimates the extra time t1.

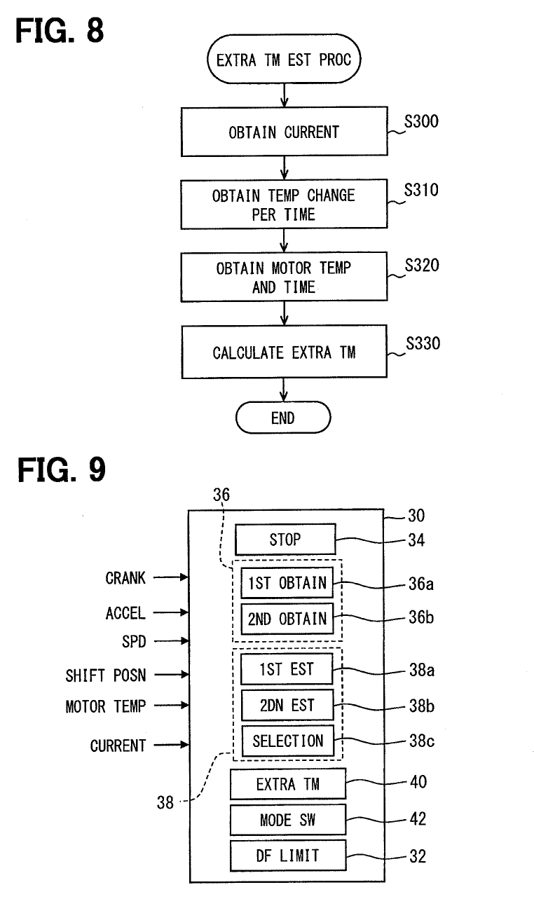

FIG. 8 illustrates an example of the extra time estimation processing. As described in FIG. 8, the electronic control device 30 obtains the value of the current flowing in the motor 14 (S300). The current value may be obtained from a current sensor, or the like, used for a control of the motor 14, for example. Therefore, it is unnecessary to newly provide a physical quantity detection portion.

The electronic control device 30 obtains a temperature change per unit time from a stored data (S310). The temperature change corresponds to an obtained current value. A relationship between the current value and the temperature change per unit time is determined in advance, and, for example, is stored in the ROM as a map, a correspondence table, or the like.

The electronic control device 30 obtains a present motor temperature and the time (S320). The extra time #1 is calculated from the temperature change per unit time obtained in S310, the motor temperature and time obtained in S320, and the upper limit temperature T2 (S330).

As described above, when the value of the current flowing in the motor 14 is used, it is possible that the extra time t1 is calculated. Therefore, the electronic control device 30 described in the present embodiment has the effects similar to the electronic control device 30 in the first embodiment.

Incidentally, in FIGS. 8, S300 and S320 correspond to an obtaining portion, and S310 and S330 correspond to an estimation portion in the present disclosure.

### Third Embodiment

In the third embodiment, a description about a part common with the electronic control device 30 in the above embodiment will be omitted,

In the present embodiment, as described in FIG. 9, the obtaining portion 36 includes a first obtaining part 36a that obtains the motor temperature and the time, and a second obtaining part 36b that obtains a value of the current flowing in the motor 14.

The estimation portion 38 includes a first estimation part 38a, a second estimation part 38b, and a selection part 38c. The first estimation part 38a calculates a temperature change per unit time from the previous value of the obtained motor temperature and the time and the present value of the motor temperature and the time, and estimates the first extra time t1a. The second estimation part 38b calculates a temperature change per unit time from the obtained current value, and estimates the second extra time t1b. The selecting portion 38c selects the shorter one of the first extra time t1a and the second extra time t1b as the extra time t1. Incidentally, the first extra time t1a corresponds to a first extra time period, and the second extra time t1b corresponds to a second extra time period in the present disclosure.

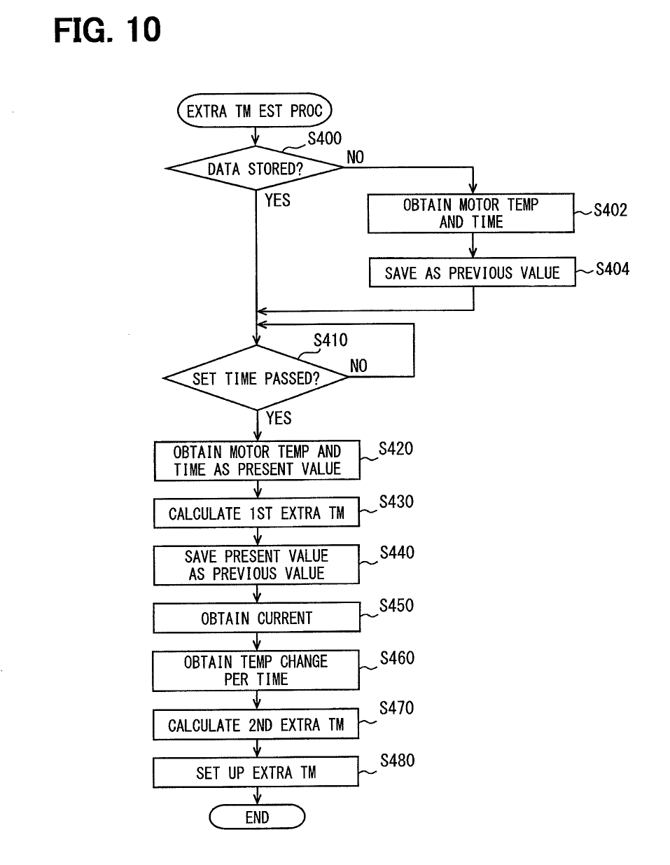

FIG. 10 illustrates an example of the extra time estimation processing. S400 to S440 described in FIG. 10 correspond to S100 to S140 described in FIG. 4. In S430, the first extra time t1a is calculated. Incidentally, S402 and S420 correspond to a first obtaining part in the present disclosure. 8430 corresponds to a first estimation part.

S450 to S470 described in FIG. 10 correspond to S300 to S330 described in FIG. 8. Incidentally, in S470, the second extra time t1b is calculated by reading out the previous value stored in the RAM in S440. Incidentally, S450 corresponds to a second obtaining part in the present disclosure. S460 and S470 correspond to a second estimation part.

In S480, the electronic control device 30 sets up the shorter one of the first extra time t1a and the second extra time t1b as the extra time t1. S480 corresponds to a selection part in the present disclosure.

As described above, when the value of the current flowing in the motor 14 is used, it is possible to calculate the extra time t1. Therefore, the electronic control device 30 described in the present embodiment has the effects similar to the electronic control device 30 in the first embodiment.

According to the embodiment, the shorter one among the first extra time t1a and the second extra time t1b, which are calculated based on mutually different physical quantities, is set up as the extra time t1. Therefore, it is possible that the engine 12 is driven more surely before the motor temperature reaches the upper limit temperature T2, that is, before the driving force of the motor 14 is limited.

As mentioned above, although desirable embodiments of the present disclosure are described, this disclosure is not limited to the embodiments mentioned above. The present disclosure may be performed variously in a range without departing from a main point of the present disclosure.

The hybrid vehicle 10, to which the electronic control device 30 is applied, is not limited to a hybrid vehicle having the above drive system. That is, the hybrid vehicle may be another drive system, including an engine travelling mode. In the engine travelling mode, an actuation of the motor 14 is stopped and only the engine 12 is used as the power source. When the extra time t1 is equal to or less than the predetermined time t2, the travelling mode may be switched into the engine travelling mode, for example.

In the present embodiment, the engine 12 is driven when the extra time t1 becomes equal to or less than the predetermined time t2. Alternatively, it may be determined whether the predetermined time has been passed after the extra time t1 is calculated in S60 of FIG. 3, and the engine 12 may be driven when the predetermined time is passed. That is, the extra time determination portion 40 may determine whether the predetermined time is passed after the extra time t1 has been estimated.

According to one aspect of the present disclosure, an electronic control device mounted to a hybrid vehicle and controlling the hybrid vehicle is provided. The hybrid vehicle has an engine and a motor as a power source generating a driving force for driving a driving shaft of the hybrid vehicle and has a driving force limitation portion limiting a driving force of the motor when a motor temperature is equal to or more than a predetermined upper limit temperature. The electronic control device includes a stop determination portion, an obtaining portion, an estimation portion, an extra time determination portion, and a switching portion. The stop determination portion determines whether the hybrid vehicle is in a motor travelling mode where only the motor is used as the power source, and whether the hybrid vehicle is in a vehicle stop state where the driving force of the motor is balanced with a slide down force applied to the hybrid vehicle in a slide down direction by gravity. The obtaining portion obtains a physical quantity from an external of the electronic control device so as to estimate an extra time before the motor temperature reaches the upper limit temperature when the stop determination portion determines that the hybrid vehicle is in the motor travelling mode and in the vehicle stop state. The estimation portion calculates a temperature change of the motor per unit time based on the physical quantity obtained by the obtaining portion, and estimating the extra time based on the calculated temperature change. The extra time determination portion determines whether the extra time estimated by the estimation portion reaches a predetermined time. The switching portion switches a travelling mode of the hybrid vehicle from the motor travelling mode to a hybrid travelling mode when the extra time determination portion determines that the extra time reaches the predetermined time, in which the hybrid travelling mode uses at least the engine as the power source.

According to the above technical features, it is possible that the extra time, which is the amount of a time before the motor temperature reaches the upper limitation temperature, is estimated, and It is possible to drive the engine before the motor temperature reaches the upper limitation temperature, that is, before the driving force of the motor is limited. Therefore, it is possible to prevent the slide down of a vehicle on an uphill.

In addition, when the extra time reaches a predetermined time, an engine is driven. That is, since the engine is not driven as much as possible, it is possible to prevent the slide down and to improve a fuel efficiency.

While the present disclosure has been described with reference to examples thereof, it is to be understood that the disclosure is not limited to the examples and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An electronic control device mounted to a hybrid vehicle and controlling the hybrid vehicle, which has an engine and a motor as a power source for generating a driving force driving a driving shaft of the hybrid vehicle and has a driving force limitation portion limiting a driving force of the motor when a motor temperature becomes equal to or more than a predetermined upper limit temperature, the electronic control device comprising:
a stop determination portion determining whether the hybrid vehicle is in a motor travelling mode where only the motor is used as the power source, and whether the hybrid vehicle is in a vehicle stop state where the driving force of the motor is balanced with a slide down force applied to the hybrid vehicle in a slide down direction by a gravity;
an obtaining portion obtaining a physical quantity from an external of the electronic control device so as to estimate an extra time before the motor temperature reaches the upper limit temperature when the stop determination portion determines that the hybrid vehicle is in the motor travelling mode and in the vehicle stop state;
an estimation portion calculating a temperature change of the motor per unit time based on the physical quantity obtained by the obtaining portion, and estimating the extra time based on the calculated temperature change;
an extra time determination portion determining whether the extra time estimated by the estimation portion reaches a predetermined time; and
a switching portion switching a travelling mode of the hybrid vehicle from the motor travelling mode to a hybrid travelling mode when the extra time determination portion determines that the extra time reaches the predetermined time, wherein the hybrid travelling mode uses at least the engine as the power source.

2. The electronic control device according to claim 1, wherein
the obtaining portion obtains the motor temperature and a time when the motor temperature is obtained, and
the estimation portion calculates the temperature change per unit time from a previous motor temperature, a previous time when the previous motor temperature is obtained, a present motor temperature and a present time when the present motor temperature is obtained.

3. The electronic control device according to claim 1, wherein
the obtaining portion obtains a value of a current flowing in the motor, and
the estimation portion calculates the temperature change per unit time from the current value.

4. The electronic control device according to claim 1, wherein
the obtaining portion includes a first obtaining part and a second obtaining part,
the estimation portion includes a first estimation part, a second estimation part, and a selection part,
the first obtaining part obtains the motor temperature and a time when the motor temperature is obtained,
the second obtaining part obtains a value of a current flowing in the motor,
the first estimation part calculates the temperature change per unit time from a previous motor temperature, a previous time when the previous motor temperature is obtained, a present motor temperature and a present time when the present motor temperature is obtained, and estimates a first extra time period,
the second estimation part calculates the temperature change per unit time from the obtained current value, and estimates a second extra time period, and
the selection part selects a shorter one of the first extra time period and the second extra time period as the extra time.

5. The electronic control device according to claim 1, wherein
the extra time determination portion determines whether the extra time estimated by the estimation portion is equal to or less than the predetermined time.

6. The electronic control device according to claim 1, wherein
the slide down direction corresponds to a downward direction along a slope of a road.
